(19) United States
(12) Patent Application Publication
(10) Pub. No.: US 2012/0323524 A1
(43) Pub. Date: Dec. 20, 2012

(54) COORDINATE DETECTING DEVICE AND COORDINATE DETECTING PROGRAM

(76) Inventor: Naoyuki Hatano, Miyagi-ken (JP)

(21) Appl. No.: 13/527,174

(22) Filed: Jun. 19, 2012

(30) Foreign Application Priority Data
Jun. 20, 2011 (JP) 2011-136628

(51) Int. Cl. G01B 7/004; G06F 15/00

(52) U.S. Cl. 702/150

(57) ABSTRACT

A coordinate detecting device includes a detecting unit configured to detect the capacitance of each of a plurality of electrodes which are arranged in a predetermined direction, a storage unit configured to store the detected capacitance of each electrode, and an arithmetic processing unit configured to perform an arithmetic process on the basis of the capacitance of each electrode stored in the storage unit. The detecting unit sequentially detects the capacitance of the plurality of electrodes from one end to the other end of the predetermined direction. The arithmetic processing unit determines a coordinate region of a detection target in the predetermined direction on the basis of a comparison value between capacitance variations of adjacent electrodes and the magnitude of the detected capacitance variation of each electrode.

### CLAIM OF PRIORITY

This application claims benefit of Japanese Patent Application No. 2011-136628 filed on Jun. 20, 2011, which is hereby incorporated by reference in its entirety.

### BACKGROUND

1. Field of the Disclosure

The present disclosure relates to a coordinate detecting device and a coordinate detecting program, and more particularly, to a coordinate detecting device and a coordinate detecting program related to an operation on a screen.

2. Description of the Related Art

In recent years, a device including a coordinate detecting device which specifies a position where a finger touches to operate an electronic apparatus has been actively developed in electronic apparatuses, such as a computer, a mobile phone terminal, and a PDA (Personal Digital Assistant).

For example, as the device that includes a coordinate detecting device, there is a pointing device (coordinate input device), which is called a pad, a touch pad, or a track pad, provided in the computer. The coordinate input device is incorporated into a portable notebook personal computer or is attached to the outside of a desktop computer, and is then used. In this case, it is not necessary to move the coordinate input device, unlike a mouse. Therefore, it is possible to operate the coordinate input device in a limited space, such as on a desk, without any difficulty.

For example, in a portable apparatus, such as a mobile phone terminal or a PDA in which the coordinate detecting device is incorporated into a display screen, the user can directly touch the display screen (operation surface) with the fingers to perform a desired operation.

For example, as the coordinate detecting device, there is a device which uses a variation in capacitance formed between an electrode and a portion around the electrode due to the contact of the finger of the user. In general, a capacitance-type coordinate detecting device includes a plurality of electrodes that are arranged in a matrix in the X-axis direction and the Y-axis direction and a detecting unit that detects a variation in the capacitance of each electrode, and detects electrodes with a large capacitance variation in the X-axis direction and the Y-axis direction among the plurality of electrodes, thereby specifying the position where the user touches.

In addition, in recent years, a coordinate detecting device has been proposed which detects the touch of two fingers at the same time such that the user can perform an intuitive and simple operation and various operations can be performed according to the positions or operation of the two fingers. When two fingers touch the operation surface, a large capacitance variation occurs at two points in each of the X-axis direction and the Y-axis direction. Therefore, it is necessary to detect the points and determine the user's input gesture. In this case, in order to accurately determine the gesture, a technique is needed which accurately and simply detects a region which a plurality of fingers touch.

For example, U.S. Pat. No. 5,825,352 discloses a technique which detects the maximum value and the minimum value of the capacitance variations of a plurality of electrodes, thereby determining multi-touch. Specifically, a method has been proposed which detects the maximum value of a capacitance variation corresponding to the first finger, detects the minimum value following the detected maximum value, and detects a second maximum value corresponding to the second finger which follows the detected minimum value.

However, in U.S. Pat. No. 5,825,352, in order to determine the maximum value and the minimum value of the capacitance variations of the plurality of electrodes, it is necessary to store and compare all data of all electrodes. In this case, the size of the storage area of the storage unit needs to be increased, which may result in an increase in the size of the circuit. In addition, when the capacitance variations of all electrodes are stored and compared, a complicated arithmetic process is needed. In particular, there is a demand for a small coordinate detecting device provided in an electronic apparatus, such as a notebook personal computer or a portable terminal apparatus.

### SUMMARY

A coordinate detecting device includes: a plurality of electrodes arranged in a predetermined direction; a detecting unit configured to detect the capacitance of each of the plurality of electrodes; a storage unit configured to store the detected capacitance of each electrode; and an arithmetic processing unit configured to perform an arithmetic process on the basis of the capacitance of each electrode stored in the storage unit. The detecting unit sequentially detects the capacitance of the plurality of electrodes from one end to the other end of the predetermined direction. The arithmetic processing unit determines a coordinate region of a detection target in the predetermined direction on the basis of a comparison value between capacitance variations of adjacent electrodes and the magnitude of the detected capacitance variation of each electrode. According to this structure, the coordinate region which the detection target touches is detected on the basis of the comparison value between the capacitance variations of adjacent electrodes among the electrodes which are sequentially detected and the detected capacitance variation of the electrode. Therefore, it is not necessary to store the capacitance of all of the electrodes in the storage area at the same time and perform the arithmetic process. As a result, it is possible to prevent an increase in the storage area and detect the coordinate region of the detection target with ease.

According to another aspect of the invention, there is provided a coordinate detecting program that allows a computer to perform an arithmetic process for determining a coordinate region of a detection target on the basis of capacitance variations of a plurality of electrodes which are sequentially detected in a predetermined direction. The coordinate detecting program includes: a start electrode determining routine configured to determine an electrode of which an absolute value of the capacitance variation is greater than a first threshold value or an electrode which is adjacent to an opposite side of the electrode in a detection direction and of which an absolute value of a comparison value with the electrode is equal to or greater than a second threshold value among the plurality of electrodes which are sequentially detected to be a start electrode of the coordinate region; a peak passage determining routine configured to check peak passage electrodes satisfying the condition that the absolute value of a comparison value between a comparison source electrode and a comparison destination electrode which are sequentially adjacent to each other in a detection direction is greater than the second threshold value and the absolute value of a capacitance variation of the comparison source electrode is greater than that of a capacitance variation of the comparison destination electrode, among the electrodes which are detected after the start electrode; and an end electrode determining routine configured to determine the comparison source electrode satisfying the condition that the absolute value of the comparison value between the comparison source electrode and the comparison destination electrode which are sequentially adjacent to each other in the detection direction is greater than the second threshold value and the absolute value of the capacitance variation of the comparison source electrode is less than that of the capacitance variation of the comparison destination electrode, or an electrode of which the absolute value of the capacitance variation is less than the first threshold value among the electrodes which are detected after the peak passage electrodes to be an end electrode of the coordinate region.

### BRIEF DESCRIPTION OF THE DRAWINGS

FIG. 1 is a block diagram illustrating a coordinate detecting device according to an embodiment;

FIG. 2 is a diagram illustrating an operation surface of the coordinate detecting device according to this embodiment and a capacitance variation on the operation surface in the X-axis direction and the Y-axis direction;

FIGS. 3A and 3B are diagrams illustrating an example of a variation in the capacitance of each X-axis electrode in the X-axis direction;

FIG. 4 is a flowchart illustrating a process of determining a coordinate region.

### DESCRIPTION OF THE EXEMPLARY EMBODIMENTS

Disclosed is a capacitance-type coordinate detecting device which specifies the number of regions which a detection target touched on an operation surface and a coordinate region, on the basis of the magnitude of a variation in the capacitance of a plurality of electrodes which were sequentially detected and a comparison value between the capacitance variations of adjacent electrodes, without storing information about the capacitance of all of the electrodes in a storage area at the same time and performing an arithmetic process. That is, a coordinate detecting device according to an embodiment of the invention does not detect specific coordinates on the basis of the capacitance of all of the electrodes stored in the storage area, but specifies the number of touch regions and a coordinate region including peak coordinates on the basis of, for example, the comparison value between adjacent electrodes. In this way, it is possible to prevent an increase in the storage area and specify the number of regions which a detection target touches and the coordinate region with ease.

The coordinate detecting device according to the embodiment of the invention can determine the coordinate region which the detection target touches and then finely determine peak coordinates with the largest capacitance variation in the coordinate region, if necessary. In this case, an arithmetic process using various methods as a method of determining the peak coordinate can be applied and it is possible to limit the range of the arithmetic process to the coordinate region. Therefore, it is possible to simplify the arithmetic process. Next, embodiments of the invention will be described in detail with reference to the accompanying drawings.

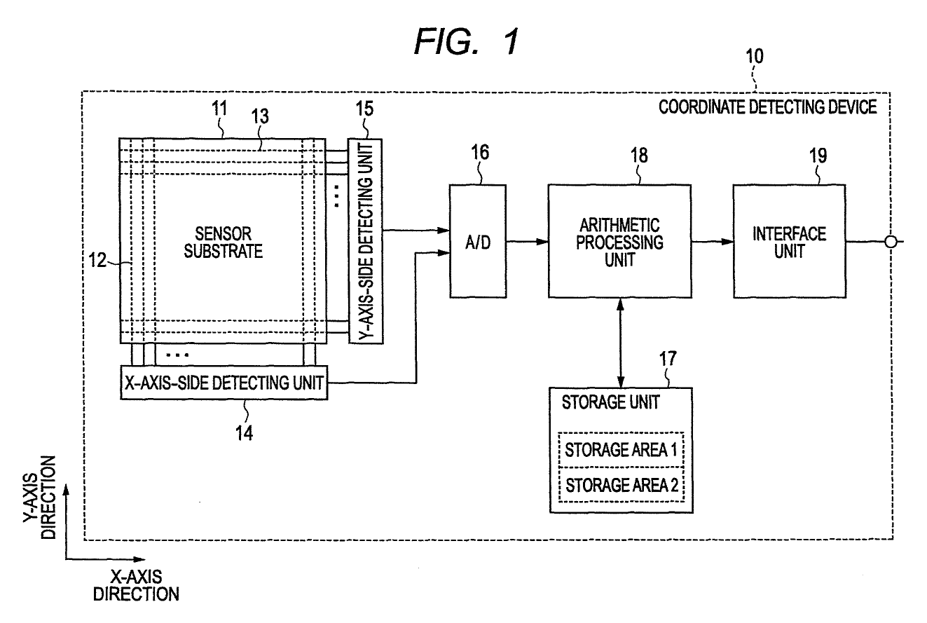

FIG. 1 is a block diagram illustrating the main structure of a coordinate detecting device according to an embodiment. A coordinate detecting device 10 shown in FIG. 1 includes a sensor substrate 11, electrodes (X-axis electrodes 12 and Y-axis electrodes 13) that are provided on the sensor substrate 11, detecting units (an X-axis-side detecting unit 14 and a Y-axis-side detecting unit 15) that detect the capacitance of each electrode, a storage unit 17 that stores, for example, the detected capacitance, and an arithmetic processing unit 18 that performs an arithmetic process using, for example, a variation in the detected capacitance of each electrode.

A plurality of X-axis electrodes 12 that detect capacitance in the X-axis direction (the lateral direction of FIG. 1) and a plurality of Y-axis electrodes 13 that detect capacitance in the Y-axis direction (the longitudinal direction of FIG. 1) are arranged in a matrix on the sensor substrate 11.

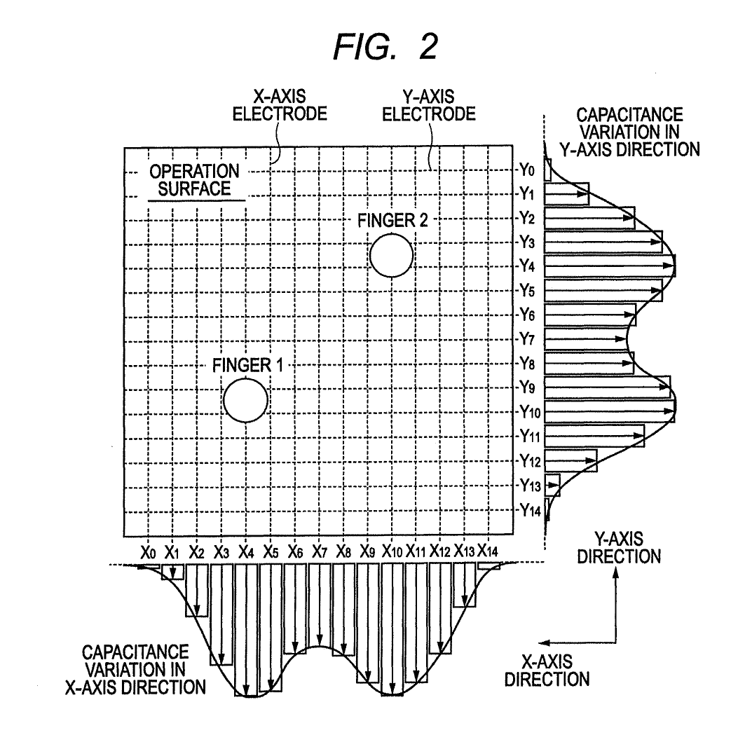

The coordinate detecting device 10 according to this embodiment is a type (capacitance type) which specifies a touch position on the basis of a variation in capacitance when a detection target, such as a finger of the user, touches the operation surface. That is, the coordinate detecting device 10 determines a coordinate region on the basis of a variation in capacitance (capacitance variation) when the detection target touches the operation surface, with respect to the capacitance value of the electrode when the detection target does not touch the operation surface. Examples of the capacitance types include a self-capacitance detection type which detects self-capacitance formed between the electrode and the ground (GND), a mutual capacitance detection type which detects mutual capacitance formed between two electrodes, and a differential mutual capacitance detection type which detects capacitance defined as the difference between the mutual capacitances between a reference electrode and two sensor electrodes. The coordinate detecting device 10 may be any type among them. In the self-capacitance detection type, the capacitance of a touched portion increases (is changed in the positive direction). In the mutual capacitance detection type, the capacitance of a touched portion decreases (is changed in the negative direction). FIG. 2 shows the detection of capacitance by the mutual capacitance detection type.

In the coordinate detecting device according to this embodiment, the X-axis electrodes 12 and the Y-axis electrodes 13 are arranged so as to be orthogonal to each other. However, for example, the arrangement or number of electrodes is not limited to the structure shown in FIGS. 1 and 2. In addition, the structure of the coordinate detecting device is not particularly limited as long as it can detect coordinates using a capacitance variation.

The X-axis-side detecting unit 14 detects the capacitance of the X-axis electrodes 12 arranged in the X-axis direction. The Y-axis-side detecting unit 15 detects the capacitance of the Y-axis electrodes 13 arranged in the Y-axis direction. It is preferable that the X-axis-side detecting unit 14 and the Y-axis-side detecting unit 15 sequentially detect the capacitance of the X-axis electrodes 12 and the Y-axis electrodes 13 arranged in the X-axis direction and the Y-axis direction, respectively. In the coordinate detecting device 10 according to this embodiment, the X-axis-side detecting unit 14 and the Y-axis-side detecting unit 15 may directly detect the capacitance variation of each electrode. In this case, the X-axis-side detecting unit 14 and the Y-axis-side detecting unit 15 compare the capacitance value of each electrode with the capacitance value (reference capacitance value) of each electrode when the detection target does not touch and obtain a capacitance variation. However, this embodiment is not limited thereto. For example, the X-axis-side detecting unit 14 and the Y-axis detecting unit 15 may detect the capacitance value of each electrode, and another circuit, such as the arithmetic processing unit 18, may compare the obtained capacitance value with the reference capacitance value, thereby calculating a variation in the capacitance of the detected electrode.

The X-axis-side detecting unit 14 can sequentially detect the capacitance of each X-axis electrode 12 from one end (X₀ side in FIG. 2) to the other end (X₁₄ side in FIG. 2) in the X-axis direction. The X-axis-side detecting unit 14 may sequentially detect the capacitance of each X-axis electrode 12, and the detection order is not limited to the direction from the electrode X₀ to the electrode X₁₄. The Y-axis-side detecting unit 15 can detect the capacitance of the plurality of Y-axis electrodes 13, similarly to the X-axis-side detecting unit 14.

An A/D (analog/digital) conversion unit 16 converts the detection signal (data for the capacitance of the X-axis electrode 12) of the X-axis-side detecting unit 14 and the detection signal (data for the capacitance of the Y-axis electrode 13) of the Y-axis-side detecting unit 15 into digital signals and supplies the digital signals to the arithmetic processing unit 18 and the storage unit 17.

The storage unit 17 has a storage area for storing the detected capacitance of the electrodes. When the capacitance of the X-axis electrodes 12 is detected, the storage unit 17 of the coordinate detecting device 10 according to this embodiment does not store the capacitance of all of the X-axis electrodes 12 (in this embodiment, the electrode X₀ to the electrode X₁₄) in the storage area at the same time, but may selectively store the capacitance of some of the X-axis electrodes 12 (at least two adjacent X-axis electrodes) in the storage area. Specifically, the storage unit 17 may store the capacitance of the X-axis electrodes which is sequentially detected by the X-axis-side detecting unit 14 and the capacitance of the electrodes adjacent to the detected electrode, and sequentially delete the capacitance of the electrodes processed by the arithmetic processing unit 18 from the storage area. In this way, it is possible to reduce the size of the storage area for storing the detected capacitance of the electrodes. This also holds for the storage of the capacitance of the Y-axis electrodes 13.

As described above, when the arithmetic processing unit 18 calculates the capacitance variation of each electrode, the capacitance value of each electrode detected by the X-axis-side detecting unit 14 is stored as capacitance in the storage unit 17. When the X-axis-side detecting unit 14 detects the capacitance variation of each electrode, the detected capacitance variation may be stored in the storage unit 17.

When the capacitance value of each electrode detected by the X-axis-side detecting unit 14 is stored in the storage unit 17, a capacitance value (a reference capacitance value (for example, “0”)) when the detection target does not touch may be stored in a first storage area portion of the storage area and the detected capacitance value of each electrode may be stored in a second storage area portion. In this case, the arithmetic processing unit 18 may compare data items to determine whether the detection target touches, thereby calculating a capacitance variation.

In this embodiment, information about the capacitance detected by the X-axis-side detecting unit 14 and the Y-axis-side detecting unit 15 is supplied to the storage unit 17 through the arithmetic processing unit 18. However, the information may be directly supplied from the X-axis-side detecting unit 14 and the Y-axis-side detecting unit 15 to the storage unit 17 through the A/D conversion unit 16.

The arithmetic processing unit 18 performs an arithmetic process using the capacitance variation based on the capacitance of the electrodes stored in the storage unit 17 to determine the number of regions which the detection target touches or the coordinate region. Specifically, the arithmetic processing unit 18 compares the capacitance variation of a predetermined X-axis electrode with the capacitance variation of the X-axis electrode adjacent to the predetermined X-axis electrode (calculates the difference between the capacitance variations), and determines, for example, a start electrode and an end electrode which define the coordinate region of the detection target on the basis of the comparison value and the magnitude of the capacitance variation of the X-axis electrodes.

In addition, the arithmetic processing unit 18 performs a coordinate region determining process using a coordinate detecting program which is stored in the storage unit 17 or a separate memory. The coordinate detecting program includes, for example, a preparatory routine, a start electrode determining routine, a peak passage determining routine, and an end electrode determining routine. The arithmetic processing unit 18 performs a series of processes according to the coordinate detecting program to specify the start electrode and the end electrode, thereby determining the coordinate region.

When it is detected that the numbers of regions which the detection target touches in the X-axis direction and the Y-axis direction are different from each other, the arithmetic processing unit 18 determines the larger one of the numbers of regions detected to be the number of regions which the detection target touches. For example, when the fingers touch two portions of the operation surface and the two touched portions are arranged in parallel in the X-axis direction or the Y-axis direction, two coordinate regions are detected in one of the X-axis direction and the Y-axis direction and no coordinate region is detected in the other direction. As such, since the number of regions which the detection target touches is specified on the basis of a simple criterion, it is possible to reduce the time required for the arithmetic process.

An interface unit 19 is a circuit for data communication between the coordinate detecting device 10 and a circuit or apparatus with a different structure. For example, when the coordinate detecting device 10 according to this embodiment is applied to a pointing device (input device), such as a touch pad of a personal computer, it may be connected to an apparatus which outputs coordinates to a display unit of the personal computer through the interface unit 19. When the coordinate detecting device according to this embodiment is incorporated into a display screen of a portable apparatus, such as a mobile phone terminal or a PDA, it may be connected to a circuit which performs an operation or process corresponding to the coordinates specified by the arithmetic processing unit 18 through the interface unit 19. As such, the coordinate detecting device according to this embodiment can be incorporated into various coordinate input devices.

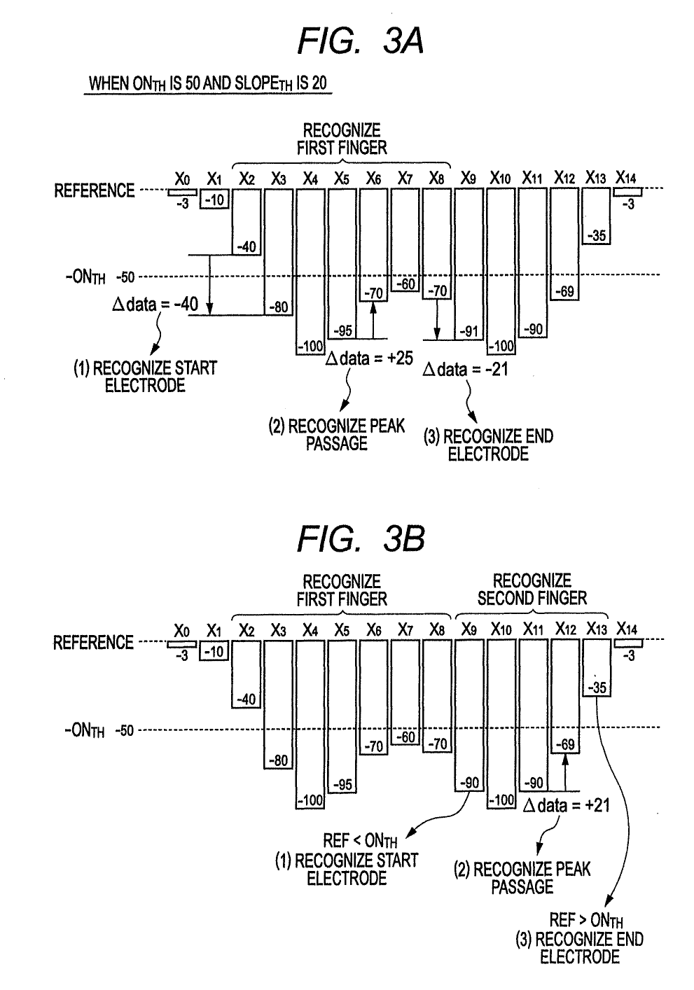

Next, the coordinate region determining process of the coordinate detecting device according to this embodiment will be described in detail. In the following description, as shown in FIG. 2 and FIGS. 3A and 3B, the coordinate region determining process when two fingers simultaneously touch the operation surface on which 15 X-axis electrodes (X₀ to X₁₉) and 15 Y-axis electrodes (Y₀ to Y₁₄) are provided in a matrix will be described. However, the number of X-axis electrodes 12 and Y-axis electrodes 13 and the number of fingers which can be detected are not limited thereto.

In this embodiment, the X-axis-side detecting unit 14 sequentially detects the capacitance of the electrodes from the electrode (X₀) at one end to the electrode (X₁₄) at the other end in the X-axis direction. The coordinate region can be determined by the same process in the X-axis direction and the Y-axis direction. Therefore, the following description focuses on the determination of the coordinate region in the X-axis direction, and a method of determining the coordinate region in the Y-axis direction may be the same as that in the X-axis direction.

In the following description, as a method of calculating the comparison value between the capacitance variations of adjacent electrodes, the left (side opposite to the detection direction) electrode of the adjacent electrodes is defined as a “comparison source electrode”, the right (side aligned with the detection direction) electrode is defined as a “comparison destination electrode”, the capacitance variation of the comparison source electrode is referred to as “REF”, and the capacitance variation of the comparison destination electrode is referred to as “TGT”. The comparison value (Δdata) between adjacent electrodes is the difference between the capacitance variation of the comparison destination electrode and the capacitance variation of the comparison source electrode (Δdata=TGT−REF). REF and TGT may be the capacitance variations of the electrodes. When the capacitance variation is converted into a current and the current is detected, REF and TGT may be current values corresponding to the capacitance variations.

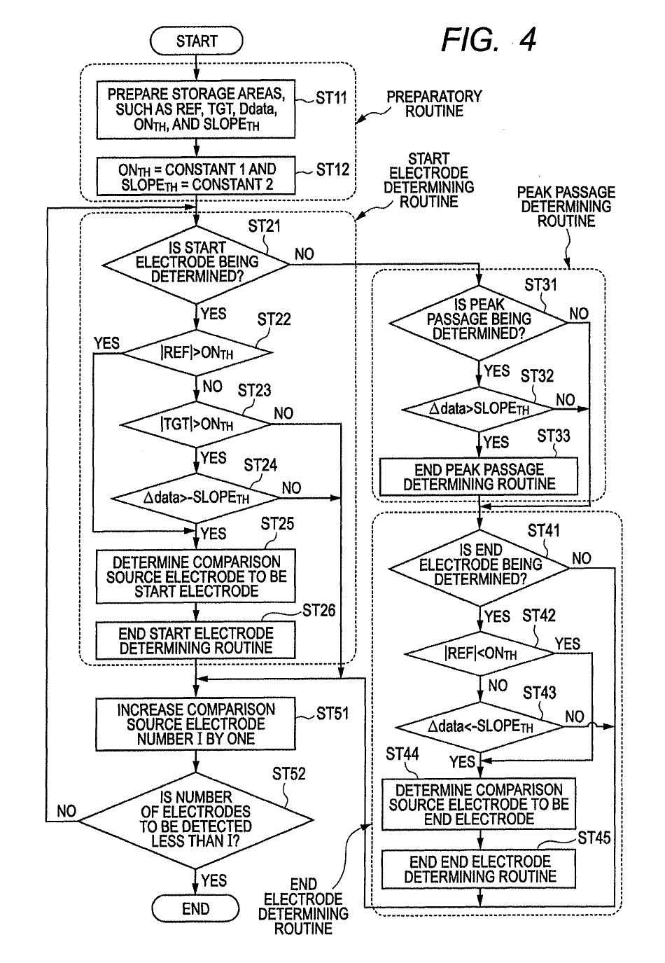

A first threshold value for determining whether the capacitance variation of the electrode is effective in the determination of the coordinate region is defined as ON_{TH} and a second threshold value for determining whether the value of Δdata indicates the touch of the finger is defined as SLOPE_{TH}. Next, an example of the coordinate region determining process of the arithmetic processing unit 18 will be described with reference to FIGS. 2 to 4. FIG. 4 is a flowchart illustrating an example of the coordinate region determining process.

<Preparatory Routine>

In the preparatory routine, first, a storage area for storing, for example, the capacitance variation (REF) of the comparison source electrode, the capacitance variation (TGT) of the comparison destination electrode, the first threshold value (ON_{TH}), and the second threshold value (SLOPE_{TH}) is prepared in the storage unit 17 (Step ST11 in, FIG. 4). Then, constants are determined as the first threshold value (ON_{TH}) and the second threshold value (SLOPE_{TH}) (Step ST12). In this embodiment, for example, the first threshold value (ON_{TH}) is set to 50 and the second threshold value (SLOPE_{TH}) is set to 20.

When predetermined constants are set as the first threshold value (ON_{TH}) and the second threshold value (SLOPE_{TH}) in the storage unit 17 in advance and the storage area for storing the capacitance variation (REF) of the comparison source electrode and the capacitance variation (TGT) of the comparison destination electrode is ensured in advance, the preparatory routine may be omitted.

<Start Electrode Determining Routine>

In the start electrode determining routine, the start electrode of the coordinate region is determined from the plurality of X-axis electrodes 12. In the start electrode determining routine, the arithmetic processing unit 18 calculates the comparison value (Δdata) between adjacent electrodes among the X-axis electrodes 12 which are sequentially detected by the X-axis-side detecting unit 14 and determines the start electrode on the basis of Δdata and the magnitude of the capacitance variation of each electrode.

For example, the arithmetic processing unit 18 may determine the X-axis electrode of which the absolute value of the capacitance variation is greater than the first threshold value (ON_{TH}) among the plurality of X-axis electrodes which are sequentially detected to be the start electrode. Alternatively, an electrode which is adjacent to one end (left side) of the X-axis electrode of which the absolute value of the capacitance variation is greater than the first threshold value (ON_{TH}) and of which the absolute value of the comparison value with the X-axis electrode is equal to or greater than the second threshold value (SLOPE_{TH}) may be determined to be the start electrode.

Specifically, among the plurality of X-axis electrodes which are sequentially detected, the comparison source electrode which satisfies one of the following two conditions (A) and (B) may be determined to the start electrode of the coordinate region:

Condition (A): when the absolute value of the capacitance variation (REF) of the comparison source electrode is greater than the first threshold value (ON_{TH}) (|REF|>ON_{TH}); and

Condition (B): when the absolute value of the capacitance variation (TGT) of the comparison destination electrode is greater than the first threshold value (ON_{TH}) and the absolute value of the comparison value (Δdata) is greater than the second threshold value (SLOPE_{TH}) (|REF|<ON_{TH}<|TGT| and |Δdata|>SLOPE_{TH}).

As such, among the plurality of X-axis electrodes which are sequentially detected, the X-axis electrode detected before the X-axis electrode of which the absolute value of the capacitance variation is greater than the first threshold value is determined to be the start electrode (condition (B)). Therefore, in the arithmetic process, even when the comparison destination electrode is a peak electrode, it is possible to set an electrode adjacent to the peak electrode as the start electrode. When only the condition (A) is applied, the start electrode can be determined regardless of Δdata.

In the condition (B), when the absolute value of TGT of the comparison destination electrode is greater than the first threshold value (ON_{TH}) and there is an electrode of which the absolute value of the comparison value (Δdata) is greater than the second threshold value (SLOPE_{TH}) among the electrodes which have been sequentially detected until that time, the comparison source electrode may be determined to be the start electrode of the coordinate region even when Δdata between the comparison destination electrode and the comparison source electrode is less than the threshold value (SLOPE_{TH}) when the absolute value of the capacitance variation is greater than the first threshold value (ON_{TH}).

Next, a start electrode determining method when the capacitance variation of the X-axis electrode is detected as shown in FIGS. 3A and 3B will be described in detail.

First, the arithmetic processing unit 18 determines whether the start electrode determining process is being performed (Step ST21). When it is determined that the start electrode determining process is being performed, the arithmetic processing unit 18 calculates the comparison value (Δdata) between adjacent X-axis electrodes among the X-axis electrodes which are sequentially detected and determines whether the condition (A) or (B) is satisfied (Steps ST22 to ST24).

First, the arithmetic processing unit 18 calculates the comparison value (Δdata) between the electrode X₀ (comparison source electrode) and the electrode X₁ (comparison destination electrode) and determines whether the conditions (A) and (B) are satisfied on the basis of the magnitude of the capacitance variations of the comparison destination electrode and the comparison source electrode.

Since REF(X₀) is −3 and TGT(X₁) is −10, |REF (X₀)|<ON_{TH} and |TGT(X₁)|<ON_{TH} are satisfied and Δdata is −7 (=(−10)−(−3)). As a result, neither the conditions (A) nor (B) is satisfied. Therefore, the arithmetic processing unit 18 increases the number I (I=0 to 14) of the X-axis electrode, which is the comparison source electrode, by 1 (X₀→X₁) (Step ST51). Then, the arithmetic processing unit 18 calculates the comparison value (Δdata) between the electrode X₁ (comparison source electrode) and the next detected electrode X₂ (comparison destination electrode) adjacent to the electrode X₁ and determines whether the conditions (A) and (B) is satisfied on the basis of TGT and REF. When neither the conditions (A) nor (B) is satisfied, the arithmetic processing unit 18 further increase the number I of the X-axis electrode, which is the comparison source electrode by 1, calculates the comparison value, and determines whether the condition (A) or (B) is satisfied.

In FIG. 3A, when the comparison source electrode is the electrode X₂ and the comparison destination electrode is the electrode X₃, REF(X₂) is −40 and TGT(X₃) is −80. Therefore, |REF(X₂)|<ON_{TH} and |TGT(X₃)|>ON_{TH} are satisfied and Δdata is −40 (=(−80)−(−40)), that is, |Δdata|>SLOPE_{TH} is satisfied. In this case, since the condition (B) is satisfied, the arithmetic processing unit 18 determines the electrode X₂, which is the comparison source electrode, to be the start electrode (Step ST25) and sets corresponding coordinates as the start coordinates of the coordinate region.

After determining the start electrode, the arithmetic processing unit 18 ends the start electrode determining routine (Step ST26) and then performs the peak passage determining routine.

<Peak Passage Determining Routine>

After determining the start electrode with the start electrode determining routine, the arithmetic processing unit 18 performs the peak passage determining routine (Steps ST31 to ST33) in order to determine the end electrode. In the peak passage determining routine, the arithmetic processing unit 18 determines the passage of the X-axis electrode with a peak (maximum) capacitance variation on the basis of the capacitance variation of the X-axis electrodes after the X-axis electrode (in this embodiment, X₂) which is determined to be the start electrode. That is, in the peak passage determining routine, the X-axis electrode with a peak capacitance variation is not calculated, but peak passage electrodes after the X-axis electrode with at least a peak capacitance variation are determined.

Specifically, it is checked whether there are electrodes satisfying the following condition: the comparison value (Δdata) between adjacent electrodes is greater than the second threshold value (SLOPE_{TH}) (Δdata>SLOPE_{TH}), that is, the absolute value of the capacitance variation (TGT) of the comparison destination electrode is less than the absolute value of the capacitance variation (REF) of the comparison source electrode and the absolute value of the comparison value (Δdata) is greater than the second threshold value (SLOPE_{TH}).

In FIG. 3A, the comparison value (Δdata) between the electrode X₅ (comparison source electrode) and the electrode X₆ (comparison destination electrode) is 25 (Δdata=(−70)−(−95)=25) and the absolute value of the comparison value is greater than the second threshold value (SLOPE_{TH}) (Yes in Step ST32). Therefore, it is determined that the X-axis electrodes detected after the electrode X₅ pass through the peak of the capacitance variation.

After determining the peak passage, the arithmetic processing unit 18 ends the peak passage determining routine (Step ST33) and performs the end electrode determining routine.

<End Electrode Determining Routine>

In the end electrode determining routine, the end electrode of the coordinate region is determined from the X-axis electrodes which are detected after the peak passage (Steps ST41 to ST45). In the end electrode determining routine, the arithmetic processing unit 18 calculates the comparison value (Δdata) between adjacent electrodes among the X-axis electrodes which are sequentially detected, and determines the end electrode on the basis of the comparison value and the magnitude of the capacitance variation of the detected electrodes.

For example, among a plurality of X-axis electrodes which are sequentially detected, the X-axis electrode of which the absolute value of the capacitance variation is less than the first threshold value (ON_{TH}) can be determined to be the end electrode (Yes in Step ST42). Alternatively, the comparison source electrode is determined to be the end electrode when the comparison value (Δdata) between the comparison source electrode and the comparison destination electrode is less than the negative second threshold value (SLOPE_{TH}) (Δdata<-sLOPE_{TH}), that is, when the absolute value of the capacitance variation (TGT) of the comparison destination electrode is greater than the absolute value of the capacitance variation (REF) of the comparison source electrode and the absolute value of the comparison value (Δdata) is greater than the second threshold value (SLOPE_{TH}) (Yes in Step ST43).

In FIG. 3A, when the comparison source electrode is the electrode X₈ and the comparison destination electrode is the electrode X₉, REF(X₈) is −70 and TGT(X₉) is −91. Therefore, |REF (X₈)|>ON_{TH} and |TGT(X₉)|>ON_{TH} are satisfied and Δdata is −21 (=(−91)−(−70)), that is, |Δdata|>SLOPE_{TH} is satisfied. In this case, the arithmetic processing unit 18 determines the electrode X₈, which is the comparison source electrode, to be the end electrode (Step ST44) and sets the corresponding coordinates as the end coordinates of the coordinate region.

The X-axis electrodes X₂ to X₈ are determined to be the coordinate region which the first finger touches in the X-axis direction by the above-mentioned arithmetic process (see FIG. 3A). Then, the arithmetic processing unit 18 ends the end electrode determining routine (Step ST45). When the electrode to be detected remains (No in Step ST52), the arithmetic processing unit 18 performs the start electrode determining routine again. Similarly to the above, the start electrode determining routine, the peak passage determining routine, and the end electrode determining routine are performed on the electrodes (X₉ to X₁₄) detected after the end electrode X₈, thereby determining the coordinate region which the second finger touches (see FIG. 3B).

In FIG. 3B, in the start electrode determining routine for the electrodes X₉ to X₁₄, when the comparison source electrode is the electrode X₉ and the comparison destination electrode is the electrode X₁₀, the absolute value of the capacitance variation (REF) of the electrode X₉ is greater than the first threshold value (ON_{TH}) and the condition (A) is satisfied. Therefore, the arithmetic processing unit 18 determines the electrode X₉ to be the start electrode.

Then, the arithmetic processing unit 18 ends the start electrode determining routine and performs the peak passage determining routine. In the peak passage determining routine, when the comparison source electrode is the electrode Xₙ and the comparison destination electrode is the electrode X₁₂, the comparison value (Δdata) is 21 (Δdata=(−69)−(−90)=21) and is greater than the second threshold value (SLOPE_{TH}). Therefore, the arithmetic processing unit 18 determines that the X-axis electrodes which are detected after the electrode X₁₁ pass through the peak of the capacitance variation.

Then, the arithmetic processing unit 18 ends the peak passage determining routine and performs the end electrode determining routine. In the end electrode determining routine, when the comparison source electrode is the electrode X₁₃, REF (X₁₃) is −35 and |REF(X₁₃)|<ON_{TH} is satisfied. In this case, the arithmetic processing unit 18 determines the electrode X₁₃, which is the comparison source electrode, to be the end electrode and sets the corresponding coordinates as the end coordinates of the coordinate region.

The X-axis electrodes X₉ to X₁₃ are determined to be the coordinate region which the second finger touches in the X-axis direction by the above-mentioned arithmetic process (see FIG. 3B). Then, the arithmetic processing unit 18 ends the end electrode determining routine (Step ST45). When the electrode to be detected remains (No in Step ST52), the arithmetic processing unit 18 performs the start electrode determining routine again. The X-axis-side detecting unit 14 ends the detection process when the detected electrode is the electrode (X₁₄) at the other end in the X-axis direction and the arithmetic processing unit 18 ends the arithmetic process when the total number of comparison source electrodes is greater than the number of electrodes to be detected and determines the last electrode to be the end electrode.

In this way, the arithmetic processing unit 18 can specify that the number of regions which the detection target touches is 2, the first finger touches the coordinate region from the electrode X₂ to the electrode X₈, and the second finger touches the coordinate region from the electrode X₉ to the electrode X₁₃ in the X-axis direction. In addition, the arithmetic processing unit 18 performs the same arithmetic process as that in the X-axis direction in the Y-axis direction to determine the coordinate regions of the first and second fingers in the Y-axis direction. In this way, it is possible to specify a position on the operation surface where the finger touches using the coordinate regions in the X-axis direction and the Y-axis direction.

In the above-mentioned processes (the start electrode determining routine, the peak passage determining routine, and the end electrode determining routine), the coordinate detecting device according to this embodiment does not store information about the capacitance of all of the X-axis electrodes 12 (electrodes X₀ to X₁₉) which are sequentially detected in the storage area of the storage unit 17 at the same time, but may selectively store information about the capacitance of some of the X-axis electrodes 12 (at least two X-axis electrodes, that is, the comparison source electrode and the comparison destination electrode) in the storage area. For example, in the start electrode determining routine, information about the capacitance of the X-axis electrodes which have been determined not to be the start electrode among the X-axis electrodes sequentially detected may be sequentially deleted from the storage area after the arithmetic process of the arithmetic processing unit 18 ends, and information about the newly detected capacitance of the X-axis electrodes may be stored (rewritten).

As such, in each process (the start electrode determining routine, the peak passage determining routine, and the end electrode determining routine), the coordinate detecting device according to this embodiment can determine the start electrode and the end electrode using a simple calculation method. Therefore, a complicated arithmetic process is not required and it is possible to determine the coordinate region with a simple arithmetic process.

After determining the coordinate region using the above-mentioned processes, the coordinate detecting device according to this embodiment may specify coordinates (peak coordinates) where the capacitance variation is the maximum due to the touch of the detection target from the detected coordinate region, if necessary. For example, the arithmetic processing unit 18 may calculate the peak coordinates from the detected coordinate region using, for example, a centroid calculation method or a quadratic curve approximation method, thereby finely specifying a region of the operation surface which the detection target touches. In this case, the arithmetic process may be applied to only the coordinate region. In this way, it is possible to simplify the arithmetic process for calculating the peak coordinates.

The invention is not limited to the above-described embodiment. Various modifications and changes of the invention can be made without departing from the scope and spirit of the invention.

It should be understood by those skilled in the art that various modifications, combinations, sub-combinations and alterations may occur depending on design requirements and other factors insofar as they are within the scope of the appended claims of the equivalents thereof.

What is claimed is:

1. A coordinate detecting device comprising:
a plurality of electrodes arranged in a predetermined direction;
a detecting unit configured to detect the capacitance of each of the plurality of electrodes;
a storage unit configured to store the detected capacitance of each electrode; and
an arithmetic processing unit configured to perform an arithmetic process on the basis of the capacitance of each electrode stored in the storage unit,
wherein the detecting unit sequentially detects the capacitance of the plurality of electrodes from one end to the other end of the predetermined direction, and
the arithmetic processing unit determines a coordinate region of a detection target in the predetermined direction on the basis of a comparison value between capacitance variations of adjacent electrodes and the magnitude of the detected capacitance variation of each electrode.

2. The coordinate detecting device according to claim 1,
wherein the arithmetic processing unit determines an electrode of which an absolute value of the capacitance variation is greater than a first threshold value or an electrode which is adjacent to one end of the electrode and of which an absolute value of the comparison value with the electrode is equal to or greater than a second threshold value among the plurality of electrodes which are sequentially detected to be a start electrode of the coordinate region.

3. The coordinate detecting device according to claim 2,
wherein the arithmetic processing unit checks peak passage electrodes satisfying the condition that the absolute value of the comparison value between a comparison source electrode and a comparison destination electrode which are sequentially adjacent to each other in a detection direction is greater than the second threshold value and the absolute value of the capacitance variation of the comparison source electrode is greater than that of the capacitance variation of the comparison destination electrode, among the electrodes which are detected after the start electrode, and
the arithmetic processing unit determines the comparison source electrode satisfying the condition that the absolute value of the comparison value between the comparison source electrode and the comparison destination electrode which are sequentially adjacent to each other in the detection direction is greater than the second threshold value and the absolute value of the capacitance variation of the comparison source electrode is less than that of the capacitance variation of the comparison destination electrode, or an electrode of which the absolute value of the capacitance variation is less than the first threshold value among the electrodes which are detected after the peak passage electrodes to be an end electrode of the coordinate region.

4. The coordinate detecting device according to claim 1,
wherein, when the detected electrode is at the other end of the predetermined direction, the detecting unit ends the detection.

5. The coordinate detecting device according to claim 2,
wherein, when the detected electrode is at the other end of the predetermined direction, the detecting unit ends the detection.

6. The coordinate detecting device according to claim 3,
wherein, when the detected electrode is at the other end of the predetermined direction, the detecting unit ends the detection.

7. The coordinate detecting device according to claim 1, further comprising:
a plurality of orthogonal electrodes arranged in an orthogonal direction perpendicular to the predetermined direction,
wherein the arithmetic processing unit determines the coordinate region of the detection target in the orthogonal direction using the same process as that for determining the coordinate region of the detection target in the predetermined direction, and
the arithmetic processing unit determines the larger one of the number of coordinate regions of the detection target in the predetermined direction and the number of coordinate regions of the detection target in the orthogonal direction to be the number of regions which the detection target touches.

8. The coordinate detecting device according to claim 2, further comprising:
a plurality of orthogonal electrodes arranged in an orthogonal direction perpendicular to the predetermined direction,
wherein the arithmetic processing unit determines the coordinate region of the detection target in the orthogonal direction using the same process as that for determining the coordinate region of the detection target in the predetermined direction, and
the arithmetic processing unit determines the larger one of the number of coordinate regions of the detection target in the predetermined direction and the number of coordinate regions of the detection target in the orthogonal direction to be the number of regions which the detection target touches.

9. The coordinate detecting device according to claim 3, further comprising:
a plurality of orthogonal electrodes arranged in an orthogonal direction perpendicular to the predetermined direction,
wherein the arithmetic processing unit determines the coordinate region of the detection target in the orthogonal direction using the same process as that for determining the coordinate region of the detection target in the predetermined direction, and
the arithmetic processing unit determines the larger one of the number of coordinate regions of the detection target in the predetermined direction and the number of coordinate regions of the detection target in the orthogonal direction to be the number of regions which the detection target touches.

10. The coordinate detecting device according to claim 4, further comprising:
a plurality of orthogonal electrodes arranged in an orthogonal direction perpendicular to the predetermined direction,
wherein the arithmetic processing unit determines the coordinate region of the detection target in the orthogonal direction using the same process as that for determining the coordinate region of the detection target in the predetermined direction, and
the arithmetic processing unit determines the larger one of the number of coordinate regions of the detection target in the predetermined direction and the number of coordinate regions of the detection target in the orthogonal direction to be the number of regions which the detection target touches.

11. The coordinate detecting device according to claim 5, further comprising:
a plurality of orthogonal electrodes arranged in an orthogonal direction perpendicular to the predetermined direction,
wherein the arithmetic processing unit determines the coordinate region of the detection target in the orthogonal direction using the same process as that for determining the coordinate region of the detection target in the predetermined direction, and
the arithmetic processing unit determines the larger one of the number of coordinate regions of the detection target in the predetermined direction and the number of coordinate regions of the detection target in the orthogonal direction to be the number of regions which the detection target touches.

12. The coordinate detecting device according to claim 6, further comprising:
a plurality of orthogonal electrodes arranged in an orthogonal direction perpendicular to the predetermined direction,
wherein the arithmetic processing unit determines the coordinate region of the detection target in the orthogonal direction using the same process as that for determining the coordinate region of the detection target in the predetermined direction, and
the arithmetic processing unit determines the larger one of the number of coordinate regions of the detection target in the predetermined direction and the number of coordinate regions of the detection target in the orthogonal direction to be the number of regions which the detection target touches.

13. The coordinate detecting device according to claim 1,
wherein the arithmetic processing unit compares the capacitance value of the electrode detected by the detecting unit with a reference capacitance value and calculates the capacitance variation of the electrode.

14. A coordinate input device comprising:
a unit that controls the input of coordinates, the unit comprising a coordinate detecting device comprising:
a plurality of electrodes arranged in a predetermined direction;
a detecting unit configured to detect the capacitance of each of the plurality of electrodes;
a storage unit configured to store the detected capacitance of each electrode; and
an arithmetic processing unit configured to perform an arithmetic process on the basis of the capacitance of each electrode stored in the storage unit,
wherein the detecting unit sequentially detects the capacitance of the plurality of electrodes from one end to the other end of the predetermined direction, and
the arithmetic processing unit determines a coordinate region of a detection target in the predetermined direction on the basis of a comparison value between capacitance variations of adjacent electrodes and the magnitude of the detected capacitance variation of each electrode.

15. A non-transitory computer readable medium, comprising computer program code stored thereon, executable by a processor, wherein the computer program code comprises a coordinate detecting program that allows a computer to perform an arithmetic process for determining a coordinate region of a detection target on the basis of capacitance variations of a plurality of electrodes which are sequentially detected in a predetermined direction, the program comprising:
a start electrode determining routine configured to determine an electrode of which an absolute value of the capacitance variation is greater than a first threshold value or an electrode which is adjacent to an opposite side of the electrode in a detection direction and of which an absolute value of a comparison value with the electrode is equal to or greater than a second threshold value among the plurality of electrodes which are sequentially detected to be a start electrode of the coordinate region;
a peak passage determining routine configured to check peak passage electrodes satisfying the condition that the absolute value of a comparison value between a comparison source electrode and a comparison destination electrode which are sequentially adjacent to each other in a detection direction is greater than the second threshold value and the absolute value of a capacitance variation of the comparison source electrode is greater than that of a capacitance variation of the comparison destination electrode, among the electrodes which are detected after the start electrode; and
an end electrode determining routine configured to determine the comparison source electrode satisfying the condition that the absolute value of the comparison value between the comparison source electrode and the comparison destination electrode which are sequentially adjacent to each other in the detection direction is greater than the second threshold value and the absolute value of the capacitance variation of the comparison source electrode is less than that of the capacitance variation of the comparison destination electrode, or an electrode of which the absolute value of the capacitance variation is less than the first threshold value among the electrodes which are detected after the peak passage electrodes to be an end electrode of the coordinate region.
